(19) United States
(12) Patent Application Publication
(10) Pub. No.: US 2003/0025262 A1
(43) Pub. Date: Feb. 6, 2003

(54) Drawer front clamping device

(76) Inventor: Bruce W. Kranzler, Tomales, CA (US)

Correspondence Address: Bruce W. Kranzler, PO Box 66, Tomales, CA, 94971, US

(21) Appl. No.: 09/910,595

(22) Filed: Jul. 21, 2001

(51) Int. Cl. B25B 1/10

(52) U.S. Cl. 269/249

(57) ABSTRACT

A clamp used in the manufacture of cabinets to aid in the blind fastening of finished drawer fronts to drawer boxes. The clamp is comprised of an inverted U shaped channel(6) of a predetermined length. The top section(6b) of the channel is sufficiently thin to fit in the desired spaces between drawer fronts or other finished cabinet members commonly referred to as “reveals”. Further, the top section is substantially flat on the exterior surface. The channel is of sufficient width from side to side to contain the finished drawer front (17), the front of the drawer box (16) and the rigid plate (13) and necessary play. A shaft (7) is passes through side (6a) of the channel and a rigid plate (13) is attached by pivotable means to the end of the shaft projecting into the channel. The shaft and plate are advanced toward the opposite side (6c) of the channel by threaded, friction or cam action means. Clamp is placed over the front of the drawer box while drawer is installed and closed, the finished drawer front is then slid under the clamp and positioned relative to adjacent cabinet members. The shaft is then advanced toward the opposite side by threaded, cam action, or frictional means thereby pressing the pieces together and temporarily holding them fast. The drawer may then be pulled out and the finished drawer front permanently blind fastened from behind. A spacer (12) may be used on the top of the channel (6b) to attain predetermined wider spacing as required. An anti-slip materiel (9) may be used on the surfaces that contact the drawer front and drawer box to enhance gripping characteristic

### FIELD OF THE INVENTION

This invention relates to a device which would be used in the manufacture of cabinets to accurately fasten finished drawer fronts to rough drawer boxes.

### DESCRIPTION OF PRIOR ART

In the manufacture of cabinets there is a difficult problem of attaching a finished drawer front to a drawer box. Most modern cabinets are comprised of a four sided box on which the drawer track mounts. These boxes are assembled and then the track is affixed and they are mounted into the cabinet or carcase. Typically the front of this box is rough, (not finished), and designed to receive a finished drawer front. This is usually a separate piece of wood or laminant matching the adjacent doors or drawer fronts that provides for the final fit and finish of the cabinet face. The spaces, also known as “reveals” between finished drawer fronts and doors when viewed in elevation are quite small. They are as little as one sixteenth of an inch and rarely more than three sixteenths of an inch wide. The problem is two fold, these precise reveals are aesthetically inch wide. The problem is two fold, these precise reveals are aesthetically important and must be established and maintained while attaching the fronts to the previously mentioned boxes. It is complicated by the fact that the drawer front is finished and it cannot be fastened from the front and into the box. The pristine appearance of the drawer front must be maintained. Therefor, the drawer front must be held in precise relationship with the drawer box while it is pulled out of the cabinet on its drawer track. The front is then fastened from the inside of the drawer box and into the back of the finished drawer front.

This is a time consuming operation. If the drawer front shifts slightly it ruins the “reveal” thereby requiring removal, realignment and another attempt at attachment.

Currently there are numerous strategies to overcome this problem. Double sided tape is applied to the front of the drawer box and the drawer front is pressed on. This is often not strong enough to hold while the drawer is pulled out on the track and fastened from behind. Hot melt glue is stronger but does not allow for readjustment if it should become necessary. In this process the glue is applied and the drawer front is pressed onto the cabinet box while the glue is still pliable.

Still another method requires the pre drilling of oversize holes in the fronts of the rough drawer boxes. The finished drawer fronts can then be adjusted within a narrow range by loosening “washer head” screws and shifting the relatively small diameter screw shank in the oversized hole of the drawer box. The screws are then retightened to hold the new adjustment. A variation is comprised of a specialized plastic insert that does essentially the same thing. Again this is time consuming and tedious and and requires specialized hardware and machine work prior to assembly of the drawer box. Adjustments are awkward due to the aforementioned inaccessibility of the interior of the drawer box.

Further problems arise in a stack of drawers. It is often easier to remove all the drawer boxes and start from the bottom and add each consecutive drawer box and drawer front aligning each one on the way up. By doing this the top of the drawer box and drawer front are accessible for conventional clamping, as the drawer box immediately above the one being worked on has been removed. The margin (reveal) can be set off the top of the last drawer front (below) and can be held by conventional clamps so that it may be pulled out and fastened through the drawer box front and into the back of the finished drawer front. The cabinetmaker is still confronted with an inaccessible drawer box, drawer front combination at the top of the stack. There is no way of clamping the two together in the correct orientation because the top of the cabinet is in the way and conventional clamps are much too bulky to be of any use.

Again, measuring such small margins, where one sixty fourth of an inch can show is problematic. This takes a great deal of time and skill and is one of the more tedious jobs in the manufacture of cabinets. Further, all of these methods, with the exception of standard clamps, which are much too thick to fit in the required reveals, are semi permanent which is to say they cannot be easily adjusted. The elaborate means to which the cabinetmaker must resort and the various types of hardware manufactured specifically for this operation illustrate the difficulty of the task.

Applicant has uncovered no prior art that would read on this device.

### OBJECTS AND ADVANTAGES

Accordingly, several objects and advantages of the present invention are:

a) drawer fronts can be attached quickly and securely to drawer box;

b) drawer front may be easily adjusted until the perfect reveal is achieved;

c) with multiple devices, all drawer fronts in a stack can be temporarily attached to drawer boxes to check for fit prior to final attachment;

d) the clamp body itself is used to establish the reveal;

e) if readjustment becomes necessary the drawer front may be simply unclamped, shifted and reclamped without having to undo adhesive.

f) all adjustments are accomplished while drawer box/drawer front are in the exact position they will be in in the finished cabinet

Other objects and advantages of the invention not specifically enumerated will become apparent during the course of the following description with reference to the accompanying drawings wherein like numerals refer to like parts throughout.

### DRAWING FIGURES

FIG. 1 Shows an isometric view of clamping device and indicates the movable jaw actuated by turning the handle.

FIG. 2 Shows an sectional view of the clamping device. Dotted line indicates (for the purpose of illustration) the drawer box and the finished drawer front being held together by the device

FIG. 3 Shows a sectional view of multiple drawer fronts secured and spaced by multiple devices (dotted line indicating drawer boxes and cabinet carcase for the purpose of illustration)

REFERENCE NUMERALS IN DRAWINGS

| | |
|---|---|
| 5. | Handle |
| 6. | U shaped channel |
| 6a | Shaft Side of channel |
| 6b | Bottom of U shaped channel |
| 6c | Opposite side of channel |
| 7. | Threaded shaft |
| 8. | Threaded hole |
| 9. | Nonskid surface |
| 10. | Pivotable means of attachment to rigid plate |
| 12. | Spacer to achieve a predetermined space or reveal between drawer |
| | fronts |
| 13. | Moveable plate |
| 14. | Cabinet top, (dotted line, for purposes of illustration) |
| 15. | Floor of cabinet, (dotted line, for purposes of illustration) |
| 16. | Drawer box, (dotted line, for purposes of illustration) |
| 17. | Finished drawer front, (dotted line, for purposes of illustration) |

### DESCRIPTION

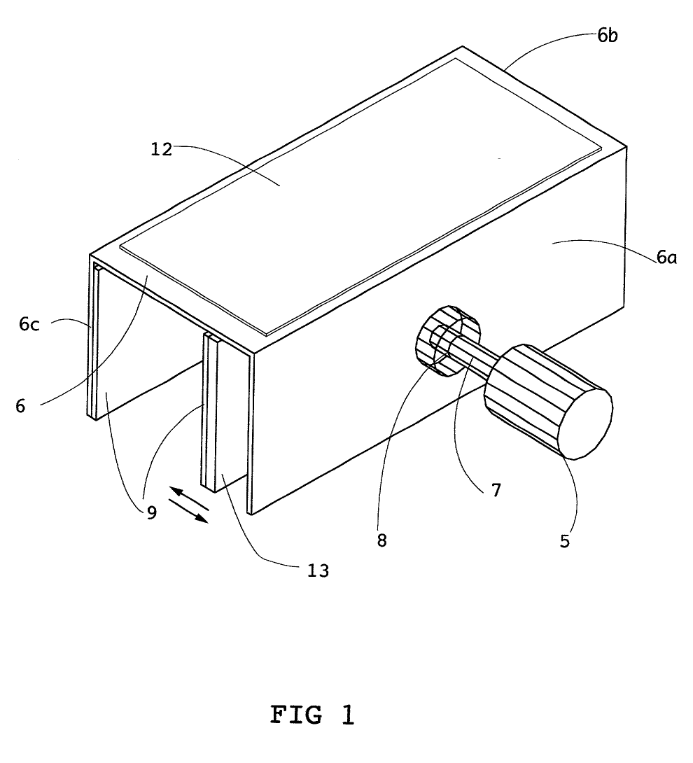

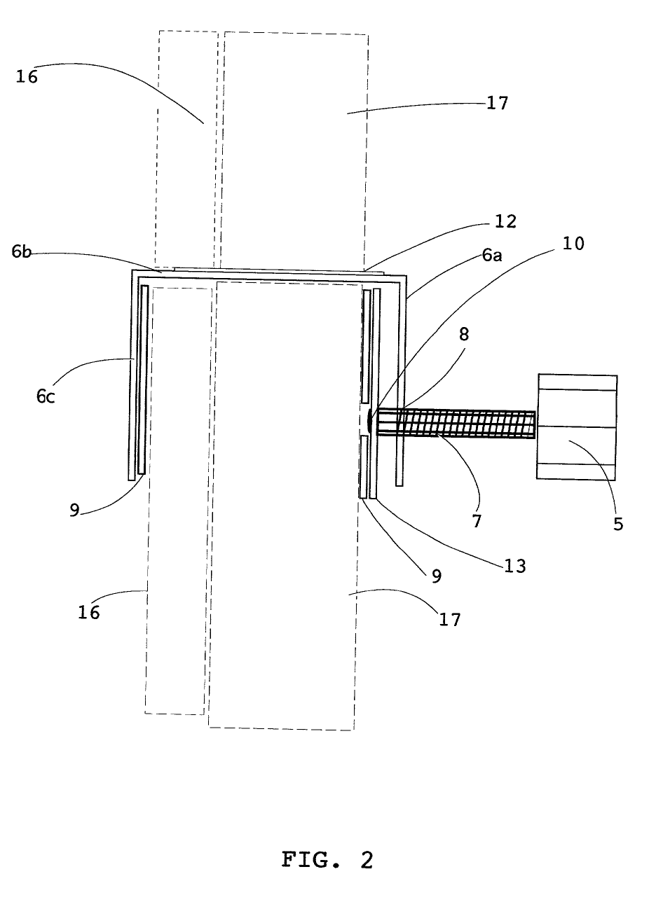

Referring to FIG. 1 and FIG. 2 throughout. The body of the device is comprised of a U shaped channel 6. The bottom of the U, 6b is thin enough to establish a narrow gap as in FIG. 2. Further, 6b is flat on the outside in order to slide past adjacent cabinet elements while clamped. In the preferred embodiment a threaded hole 8 is placed in one of the sides 6a of the channel. A threaded shaft 7 having a handle 5 at one end is screwed into the hole and pivotally attached to a plate 13. Plate 13 is inside of and substantially the same length and parallel to the aforementioned channel side 6a. The plate may be flat or curved such that the ends come into contact with the drawer front before the center does, thereby applying more pressure at the ends and creating a more secure hold.

Referring to FIG. 1 and FIG. 2 The contact surfaces of 13 and inside of opposite side of the channel 6c, receive a nonskid surface 9. A precise gap or reveal is achieved with the addition of a spacer 12 on the top of the U 6b when it is inverted.

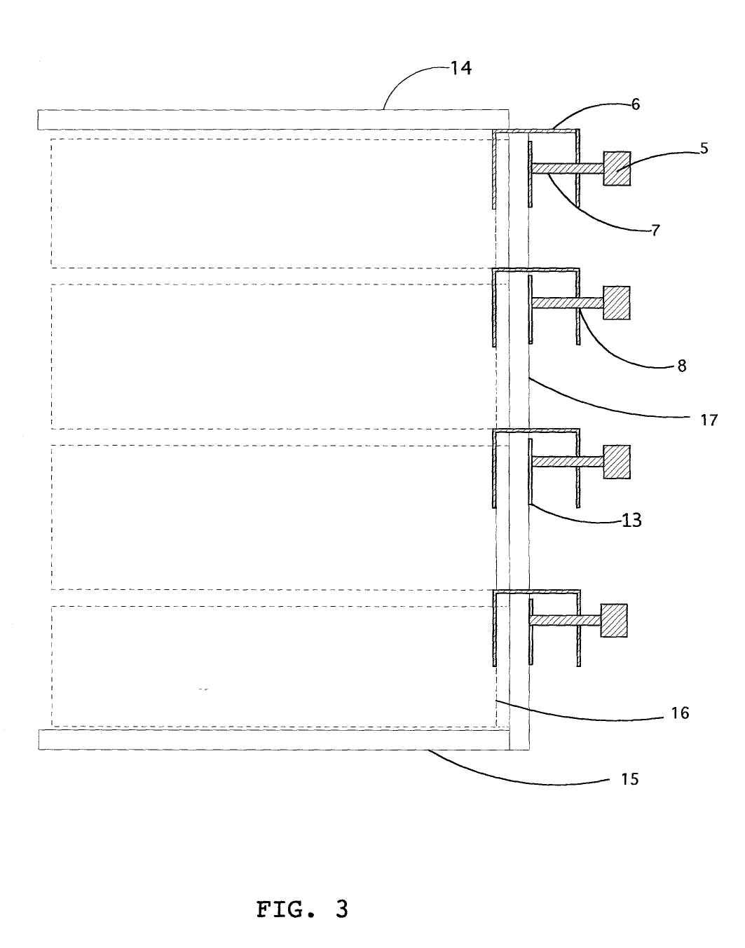

FIG. 3 shows a series of the devices used simultaneously in a stack or bank of drawers.

From the description above a number of advantages of my invention become apparent.

(a) No fastening through the finished drawer front is required.

(b) An accurate spacing or reveal is achieved between all finished drawer fronts.

(c) A drawer front may be attached temporarily and easily removed to check for fit prior to permanent attachment.

(d) One procedure clamps the front to the drawer box and establishes the reveal.

(e) The width of reveal is adjustable with the use of spacers on top of the U when it is inverted.

(f) A series of drawer fronts may be temporarily attached to check the relationship to adjacent doors and drawer fronts.

g) Drawer front is securely held and positioned until permanently fastened with no shifting.

(h) All operations are performed while drawer is in the closed position as it would be in a finished cabinet.

(h) What has been a difficult job requiring a high level of skill is reduced to a simple task.

(i) No machining is required to any of the cabinet members.

(j) The drawers do not interfere with adjacent cabinet members while clamped.

### OPERATION—FIGS. 1, 2, 3

The clamp is used for the temporary adjustment and attachment of finished drawer fronts to drawer boxes.

Referring to FIG. 1 and FIG. 2, with drawer boxes (16 shown for illustration) are assembled and installed in the cabinet (14,15, shown for illustration), a finished drawer front, (17 shown for illustration) is placed against the front of a drawer box. The drawer box is pulled slightly out of the cabinet. With the inverted clamp opened it is placed over the front of the drawer box and the finished drawer front 16 and 17 (shown for illustration). The drawer is slid back into the cabinet on its track. The drawer front is positioned for finish fit and the clamp is tightened by turning the handle 5, The drawer front and drawer box are clamped between 6a and 13. The drawer is then pulled out making the inside accessible, and the drawer front is blind fastened from the back.

Alternately, referring to FIG. 1 and FIG. 3, the above steps are completed without permanently attaching with screws. A series of clamps are used and each successive drawer front is clamped in place using the clamp body 6 and spacer, 12 to maintain the desired reveal between each drawer front. Fronts may then be attached permanently after drawers are individually pulled out on their tracks. They are also easily removed for resizing if necessary. A non slip material, 9 may be used on the contact surfaces to reduce necessary clamping pressure.

### SUMMARY

Accordingly, the reader will see that the clamping device of this invention is unique and very effective at attaching drawer fronts with speed and accuracy. Further, it solves many problems associated with this task:

it preserves the pristine quality of the drawer front;

it securely but temporarily holds the drawer front in place;

it allows for fine adjustment of the drawer front while it is in the same closed position it will be in in the finished cabinet;

it does not conflict with cabinet members above or below as with conventional clamps;

it provides for perfect accuracy;

it eliminates the need for measuring:

it allows for ease of removal should a drawer front need to be cut down or replaced;

it allows for drawer fronts to be clamped in place with out removing adjacent drawer boxes from cabinet;

it allows for independent movement of any drawer while clamped;

any drawer in the series may be removed without affecting adjacent drawer front adjustments;

it allows for multiple drawer fronts to be attached at the same time and removed if necessary;

it automatically sets the proper reveal;

it allows for progressive pressure to facilitate shifting the finished drawer front on the drawer box until final fit is achieved;

it requires no machining of cabinet members prior to placement;

it reduces a task requiring great skill to a simple procedure.

The foregoing is considered as illustrative only of the principles of the invention. Further, since numerous modifications and changes will readily occur to those skilled in the art, it is not desired to limit the invention to the exact construction and operation shown and described, and accordingly all suitable modifications and equivalents may be resorted to, falling within the scope of the invention as claimed.

I claim:

1. A clamping device used in the manufacture of cabinets to aid in the temporary attachment and alignment of a finished drawer front to a drawer box, said device maintaining the desired position of said drawer front while the drawer is pulled out of the cabinet for permanent attachment of said drawer front from behind comprising:
(a) a channel of a predetermined length substantially “u” shaped in cross section comprising, a bottom, two sides, two ends,
(b) said bottom being substantially flat on the outside and sufficiently thin to establish a predetermined space between the clamped drawer front and, adjacent drawer fronts,
(c) one or more threaded holes in one said side located a predetermined distance from the open side of the channel and substantially midway between said ends,
(d) a rigid plate of a predetermined length inside of and parallel to the side of said channel,
(e) one or more threaded rods passing through said threaded holes in the side of the channel and pivotally connected to said rigid metal strap,
(f) a handle on the opposite end of said rods,
whereby, said clamp is inverted and placed over the front of a drawer box and a finished drawer front, rotating said handle causes the rigid plate to move toward the opposite side of the channel thereby clamping said drawer front to said drawer box
whereby the bottom of said u shaped channel establishes a gap between the clamped drawer front and the drawer front immediately above, the channel is sufficiently flat to allow the assembly to be pulled out of cabinet without binding on adjacent cabinet members and the drawer front to be blind fastened from behind.

2. A clamp used in the manufacture of cabinets, said clamp being substantially u shaped in cross section, said u being of a predetermined length, comprising two side sections and one bottom section, said bottom section being flat on the outside and of sufficiently thin material to establish the desired gap between adjacent finished cabinet elements, one said side section having one or more holes, said clamp further including a shaft passing through said hole in said side section, said shaft being advanced toward opposite side by means selected from a group containing threaded, friction, sliding, or cam action means, the clamp further including a plate subststantially perpendicular to the end of the shaft which extends inside the u, said plate being substantially parallel to the sides, the opposite end of the shaft having a handle,
whereby, the clamp is inverted and placed over the installed and closed inner box of a drawer, a finished drawer front is slid under the clamp, said handle is moved such that the plate advances toward the opposite side thereby capturing said assembly, holding it fast temporarily and indexing it to adjacent finished cabinet members so that the assembly may be pulled out and permanently fastened through the inner box and into the back of said finished drawer front.

3. The clamp in claim 2 further including a curved plate, the ends of said plate being closer to said opposite side than the center of the plate,
whereby plate contacts the assembly at the ends.

4. The clamp in claim 2 further including a spacer on the outside of said bottom section.

5. The clamp in claim 2 further including a spacer on the inside of said bottom section.

6. The clamp in claim 2 further including nonskid surface on the faces on said rigid plate and said opposite side of channel.

7. A device used in the manufacture of cabinets to facilitate the temporary alignment and attachment of a finished drawer front to a drawer box so that it may be indexed to adjacent cabinet members, pulled out of the cabinet and permanently blind fastened to said drawer box from behind comprising, a channel of a predetermined length substantially u shaped in cross section, said channel having two sides and a sufficiently thin bottom section, said bottom section being substantially flat on top, said u shaped channel further including a threaded hole in one said side section, said hole receiving a threaded rod, said rod further including a handle on one end and a plate pivotally attached to the opposite end which extends through said side to the inside of said u shaped channel, said plate being substantially perpendicular to said rod and parallel to said side,
whereby turning said handle advances said plate toward opposite said side of said u shaped channel

8. The device in claim 7 further including a curved plate, the ends of said plate being closer to said opposite side than the center of the plate,
whereby plate contacts the assembly at the ends.

9 The device in claim 7 further including a spacer on the outside of said bottom section.

10. The device in claim 7 further including a spacer on the inside of said bottom section.

11. The device in claim 7 further including nonskid surface on the faces on said rigid plate and said opposite side of channel.
